(19) United States
(12) Patent Application Publication
(10) Pub. No.: US 2024/0278732 A1
(43) Pub. Date: Aug. 22, 2024

(54) VEHICLE-MOUNTED DISPLAY SYSTEM AND VEHICLE

(71) Applicant: TOYOTA JIDOSHA KABUSHIKI KAISHA, Aichi-ken (JP)

(72) Inventor: Kazuhiro KAWAMURA, Toyota-shi (JP)

(21) Appl. No.: 18/436,028

(22) Filed: Feb. 8, 2024

(30) Foreign Application Priority Data
Feb. 17, 2023 (JP) 2023-023283

(51) Int. Cl. B60R 11/02; B60R 11/00

(52) U.S. Cl. CPC B60R 11/0235; B60R 2011/0028; B60R 2011/0082; B60R 2011/0092

(57) ABSTRACT

A vehicle-mounted display system comprises a display attached to a cabin ceiling and configured to change between a flat posture and a bent posture, wherein the display in the flat posture has a flat shape along the cabin ceiling, the display in the bent posture is bent such that respective ends in a first direction are closer to each other and convex downward than in the flat posture, and the display has a display area visible from both sides in the first direction with the display therebetween.

### CROSS REFERENCE TO RELATED APPLICATION

This application claims priority to Japanese Patent Application No. 2023-23283 filed on Feb. 17, 2023, which is incorporated herein by reference in its entirety including the specification, claims, drawings, and abstract.

### TECHNICAL FIELD

This specification discloses a vehicle-mounted display system and a vehicle equipped with the vehicle-mounted display system.

### BACKGROUND

Conventionally, it has been proposed to install a display for displaying an image in a vehicle. For example, Patent Document 1 discloses a display (referred to as “video reproducing device” in Patent Document 1) installed on a ceiling of a vehicle cabin. In Patent Document 1, the indicator is swingable about its front end. Then, the display is switched between a posture accommodated in the vehicle room ceiling and a posture in which a display area faces the rear of the vehicle.

According to such a conventional technique, the indicator can be accommodated in the ceiling of the vehicle compartment. Therefore, when the display is not used, it is possible to prevent the display from interfering with the user. However, in the conventional display, only a user located on one side (the rear side of the vehicle in the example of PTL 1) of the display can be used. As a result, in the conventional display, the comfort of the user in the vehicle compartment is not sufficiently improved.

Accordingly, the present specification discloses a vehicle-mounted display system and a vehicle in which comfort of a user in a vehicle interior is further improved.

### CITATION LIST

PATENT DOCUMENT 1: WO 2002/009976 A1

### SUMMARY

A vehicle-mounted display system disclosed herein comprises a display attached to a cabin ceiling and configured to change between a flat posture and a bent posture, wherein the display in the flat posture has a flat shape along the cabin ceiling, the display in the bent posture is bent such that respective ends in a first direction are closer to each other and convex downward than in the flat posture, and the display has a display area visible from both sides in the first direction with the display therebetween.

When the display is in the bent posture, the user located on both sides of the display in the first direction can comfortably view the display. Further, when the display is in a flat posture, the display does not disturb the field of view of the user. As a result, the comfort of the user in the vehicle compartment is further improved.

The vehicle-mounted display system may further comprise a controller configured to control the display of the display area, wherein the display may be a bendable sheet-shaped display device, the display area may include a first display area visible from one side in the first direction of the display, and a second display area visible from the other side in the first direction of the display when the display is in the bent posture, the controller may be configured to treat the first display area and the second display area as a single continuous display area when the display is in the flat posture, and the controller may be configured to treat the first display area and the second display area as independent display areas when the display is in the bent posture.

With such a configuration, an image is appropriately displayed in both the flat posture and the bent posture.

The controller may be configured to: switch the posture of the display between the bent posture and the flat posture according to a type of image displayed on the display, change a bending angle, which is an angle between the first display area and the second display area, according to at least one of a user's instruction and a reclining angle of a seat seated by the user, and correct an image displayed on the display according to the bending angle.

With such a configuration, the user can more comfortably view the display.

The vehicle-mounted display system may further comprise a changing mechanism for changing the display between the flat posture and the bent posture, wherein the changing mechanism may comprise: a slide roller connected to an end of the display in the first direction: a slide rail extending in the first direction on the cabin ceiling, and which guides a sliding movement of the slide roller; and an actuator that moves the slide roller along the slide rail, and the controller may be configured to change an angle between the first display area and the second display area through the sliding movement of the slide roller.

With such a configuration, the posture of the display can be changed by simple control.

A vehicle disclosed herein comprises the vehicle-mounted display system described above, and at least two seats arranged to face each other on both sides in the first direction with the display therebetween.

With such a configuration, the user can view the display well in a state in which the user sits on the seat. As a result, the comfort of the user in the vehicle compartment is further improved.

According to the technology disclosed in this specification, the comfort of the user in the vehicle compartment can be further improved.

### BRIEF DESCRIPTION OF DRAWINGS

Embodiment(s) of the present disclosure will be described based on the following figures, wherein:

FIG. 1 is a block diagram showing a configuration of a vehicle-mounted display system;

FIG. 2 is a schematic diagram showing how the display system is used:

FIG. 3 is a schematic perspective view of the display viewed from above:

FIG. 4 is a schematic view showing how the posture of the display is changed; and

FIG. 5 is a diagram showing a relationship between the posture of a display device and a display mode of an image.

FIG. 6 is a schematic cross-sectional view of a slide rail.

### DESCRIPTION OF EMBODIMENT

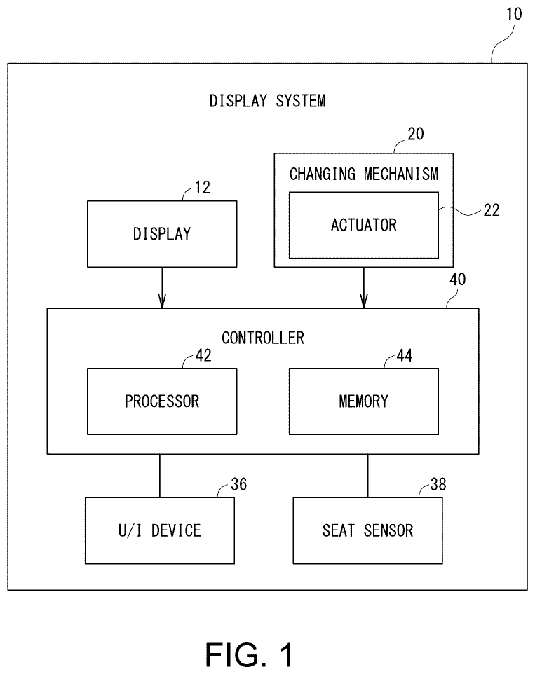

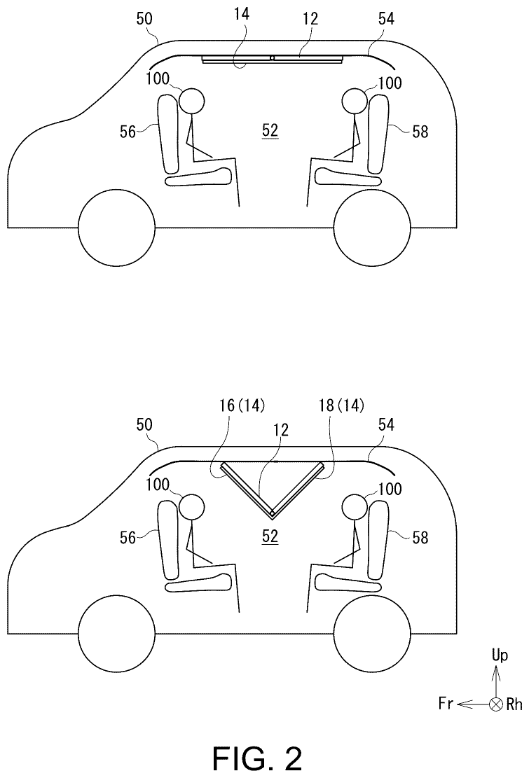

Hereinafter, the configuration of the display system 10 will be described with reference to the drawings. FIG. 1 is a block diagram showing a configuration of a display system 10. FIG. 2 is a schematic diagram showing how the display system 10 is used. In the following drawings, “Fr”, “Up” and “Rh” indicate the front side of the vehicle, the upper side of the vehicle, and the right side of the vehicle, respectively.

The display system 10 is mounted on a vehicle 50. The vehicle 50 is not particularly limited as long as it has a cabin 52. In this example, the vehicle 50 includes a front seat 56 and a rear seat 58 which are disposed opposite to each other in the longitudinal direction of the vehicle.

The display system 10 includes a display 12, a changing mechanism 20, a user interface device 36 (hereinafter referred to as “U/I device 36”), a seat sensor 38, and a controller 40. The display 12 is a display device attached to the cabin ceiling 54. The display 12 is disposed rearward of the front seat 56 and forward of the rear seat 58. In this example, the display 12 is a bendable sheet-shaped display, for example, an organic EL display. However, the display 12 may have another configuration as long as it can display an image. For example, the display 12 may be a projector that projects image light onto a sheet-shaped screen. The display 12 may be a panel-shaped display, for example, a liquid crystal display. The display 12 may be configured by combining a plurality of elements. For example, the display 12 may be configured by combining two liquid crystal display devices.

The display 12 can be changed to a flat posture and a bent posture, as will be described in detail later. The upper part of FIG. 2 shows the display 12 in the flat posture, and the lower part of FIG. 2 shows the display 12 in the bent posture. In the flat position, the display 12 is flat along the cabin ceiling 54.

For example, the display 12 may be disposed below the cabin ceiling 54 so as to overlap the cabin ceiling 54 in the thickness direction. Further, the display 12 may be fitted into an opening formed in the cabin ceiling 54. In other words, the display 12 may be disposed in the same plane as the cabin ceiling 54 in the flat posture.

As shown in the lower part of FIG. 2, in the bending posture, the display 12 is bent so as to be convex downward. In other words, in the bent posture, the display 12 has a V-shape that expands upward when viewed from the side of the vehicle. Accordingly, in the case of the bent posture, respective ends of the display 12 in the front-rear direction are closer to each other than in the flat posture.

The display 12 has a display area 14 for displaying an image. The display area 14 includes a first display area 16 visible from the front side of the display 12 and a second display area 18 visible from the rear side of the display 12 in the bent posture. In this example, the user 100 sitting on the front seat 56 sees the first display area 16, and the user 100 sitting on the rear seat 58 sees the second display area 18. In this example, the first display area 16 has the same size as the second display area 18. However, the size of the first display area 16 may be different from the size of the second display area 18 by adjusting the position of the hinge shaft 30 in the front-rear direction, which will be described later.

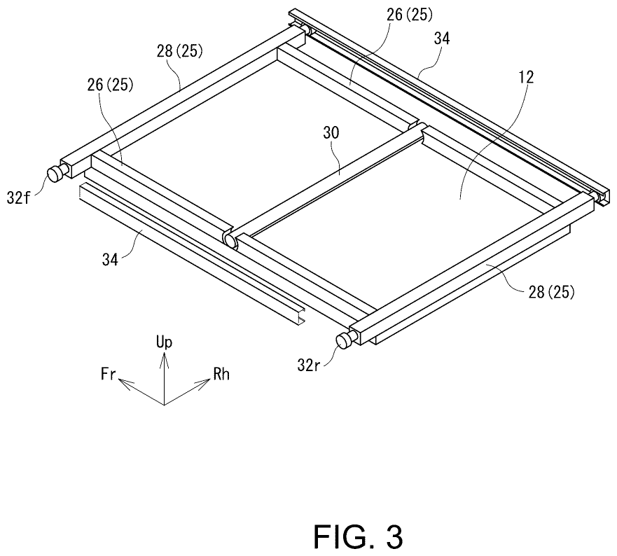

The changing mechanism 20 changes the display 12 between a flat posture and a bent posture. The configuration of the changing mechanism 20 will be described with reference to FIG. 3. FIG. 3 is a schematic perspective view of the display 12 viewed from above.

The changing mechanism 20 includes a frame body 25, a hinge shaft 30, a slide roller 32, a slide rail 34, and an actuator 22 (see FIG. 1). The frame body 25 is a frame member fixed to the rear surface (i.e., the upper surface) of the display 12 so as to extend along the peripheral edge of the display 12. The hinge shaft 30 is a rod-shaped member fixed to the rear surface of the display 12 and extending along a bending line. Both the frame body 25 and the hinge shaft 30 are made of a material which is not easily deformed, for example, a hard resin or a metal. By providing the frame body 25, the display 12 can be prevented from bending at an unintended position. The frame body 25 includes side bars 26 fixed to both ends of the display 12 in the vehicle width direction, and end bars 28 fixed to both ends of the display 12 in the front-rear direction. As shown in FIG. 3, the side bar 26 is divided at the center in the front-rear direction, that is, at a boundary line between the first display area 16 and the second display area 18. The hinge shaft 30 is disposed between two side bars 26 arranged in the front-rear direction.

The slide rollers 32f and 32r are rollers connected to respective ends of the display 12 in the front-rear direction. In the following description, when the front slide roller 32f and the rear slide roller 32r are not distinguished from each other, the subscript alphabets f and r are omitted and are referred to as a “slide roller 32”. In this example, the slide rollers 32 are connected to respective ends of the end bar 28 in the vehicle width direction. Therefore, the changing mechanism 20 includes four slide rollers 32.

The slide rail 34 is attached to the cabin ceiling 54 and guides the sliding movement of the slide roller 32. The slide rails 34 are disposed on both sides of the display 12 in the vehicle width direction. The slide rail 34 extends in the longitudinal direction of the vehicle. In FIG. 3, for easy understanding, a part of the left slide rail 34 is omitted. However, in practice, the left and right slide rails 34 are the same length as each other.

The actuator 22 (see FIG. 1) moves the slide roller 32 along the slide rail 34 by rolling the slide roller 32. The actuator 22 includes, for example, a motor (not shown) mechanically coupled to the slide roller 32. The actuator 22 may be connected to all of the four slide rollers 32, or may be connected to only one of the front and rear slide rollers 32. For example, the actuator 22 may be connected only to the two slide rollers 32f on the front side and may be configured to move the two slide rollers 32f. In this case, the two slide rollers 32r on the rear side are kept stationary without moving.

In any case, when at least a part of the slide rollers 32 slides by the actuator 22, both ends of the display 12 in the front-rear direction move closer to or away from each other. Thereby, the bending angle θ of the display 12 is changed.

Referring again to FIG. 1, the configuration of the display system 10 will be described. The U/I device 36 receives an instruction from the user 100. The U/I device 36 may be, for example, a switch or a button incorporated in the vehicle 50. The U/I device 36 may be a microphone that receives voice commands. Further, the U/I device 36 may be an information terminal capable of communicating with a controller 40, which will be described later, such as a smartphone.

The seat sensor 38 detects the states of the front seat 56 and the rear seat 58. That is, the front seat 56 and the rear seat 58 can change the front-rear position, the height, and the reclining angle. The seat sensor 38 detects the front-rear position, the height, and the reclining angle of each of the front seat 56 and the rear seat 58.

The controller 40 controls driving of the display 12 and the changing mechanism 20. The controller 40 is physically a computer having a processor 42 and a memory 44. The controller 40 is not limited to a single computer, and may be configured by combining a plurality of computers. Further, a part of the controller 40 may be disposed outside the vehicle 50.

The controller 40 drives the changing mechanism 20 to change the posture of the display 12. That is, as described above, the display 12 can be changed to a flat posture and a bent posture. The controller 40 switches between the flat posture and the bent posture based on at least one of the usage state of the display 12 and the instruction of the user 100.

For example, the controller 40 may change the posture of the display 12 according to the type of image to be displayed on the display 12. For example, when an image is not displayed on the display 12, or when an image for a predetermined flat posture is displayed, the controller 40 sets the display 12 to a flat posture. The image for the flat posture is an image set so as to be displayed on the display 12 for the flat posture, for example, an empty image or an image for a screen saver. In other words, the image for the flat posture is an image which is not actively recognized by the user 100 or an image suitable for the user 100 to see and view. When displaying other images, the controller 40 brings the display 12 into a bent posture. Alternatively, the controller 40 may switch between the flat posture and the bent posture based on an instruction from the user 100 input via the U/I device 36.

When the display 12 is in the bent posture, the user 100 of the front seat 56 can easily see the first display area 16, and the user 100 of the rear seat 58 can easily see the second display area 18. As a result, it is possible to further improve the comfort of both the user 100 of the front seat 56 and the user 100 of the rear seat 58. As described above, when the user 100 does not actively view the display 12, the controller 40 brings the display 12 into a flat posture. This prevents the display 12 from interfering with the field of view of the user 100. As a result, the comfort of the user 100 in the vehicle compartment is further improved.

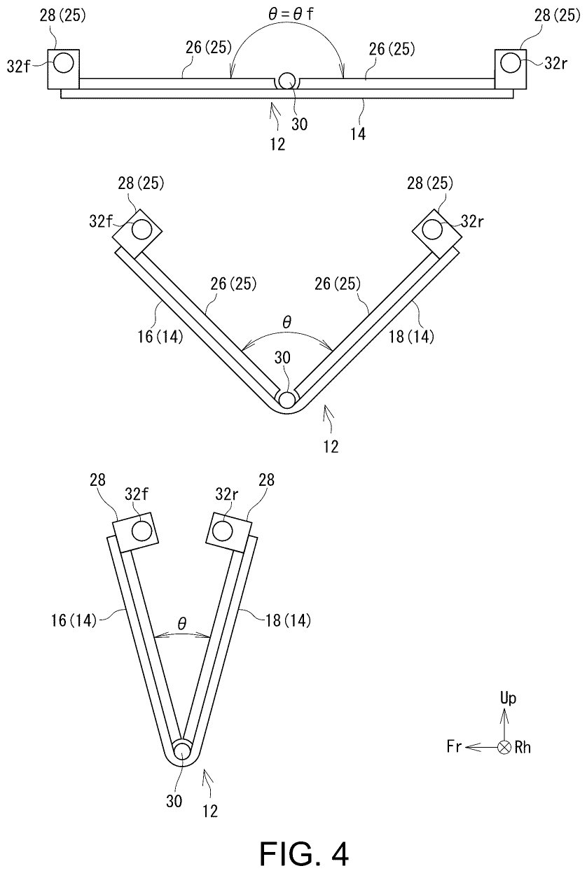

FIG. 4 is a schematic view showing how the posture of the display 12 is changed. As shown in FIG. 4, when the slide roller 32 slides, the posture of the display 12 changes. Hereinafter, the angle between the first display area 16 and the second display area 18 is referred to as “bending angle θ”. The bending angle θf in the flat posture is about 180 degrees. A state in which the bending angle θ is smaller than the angle θf is a bending posture.

The bending angle θ in the bent posture may be a fixed value or a variable value. For example, when the bending posture is selected, the controller 40 may slide the slide roller 32 so that the bending angle θ becomes a predetermined specific angle (e.g., 90 degrees).

Further, the controller 40 may continuously or stepwise change the bending angle θ based on the instruction of the user 100 and the detection result of the seat sensor 38. For example, the user 100 may be able to indicate an increase or decrease in the bending angle θ via the U/I device 36. In this case, the controller 40 slides the front and rear slide rollers 32 such that the front and rear slide rollers 32 are gradually separated from each other during a period in which an increase in the bending angle θ is instructed. Further, the controller 40 slides the front and rear slide rollers 32 so that the front and rear slide rollers 32 gradually approach each other during a period in which a decrease in the bending angle θ is instructed. Alternatively, the user 100 may select one of a plurality of predefined bending angles θ. In this case, the controller 40 slides the front and rear slide rollers 32 to the selected bending angle θ.

Alternatively, the controller 40 may change the bending angle θ according to the detection result of the seat sensor 38. For example, the controller 40 may change the bending angle θ based on the reclining angle detected by the seat sensor 38. For example, the controller 40 may increase the bending angle θ as the reclining angle increases (i.e., the seatback is closer to horizontal).

Further, the controller 40 may change the position of the display 12 in the bent state based on at least one of an instruction from the user 100 and a detection result of the seat sensor 38. The position of the display 12 can be changed by controlling the amounts of slide movement of the front and rear slide rollers 32 independently of each other. For example, as shown in the third row of FIG. 4, by sliding the rear slide roller 32r forward with the front slide roller 32f stationary, the display 12 bends and the center of the display 12 in the front-rear direction moves forward.

For example, the controller 40 may change the position of the display 12 based on instructions from the user 100. Alternatively, the controller 40 may change the position of the display 12 based on the front seat 56 and the rear seat 58 position in the front-rear direction detected by the seat sensor 38. For example, the controller 40 may change the position of the display 12 such that the longitudinal center of the display 12 is located in the middle between the front seat 56 and the rear seat 58. In any case, since the user 100 can view the display 12 more comfortably by changing the position of the display 12, the comfort of the user 100 can be further improved.

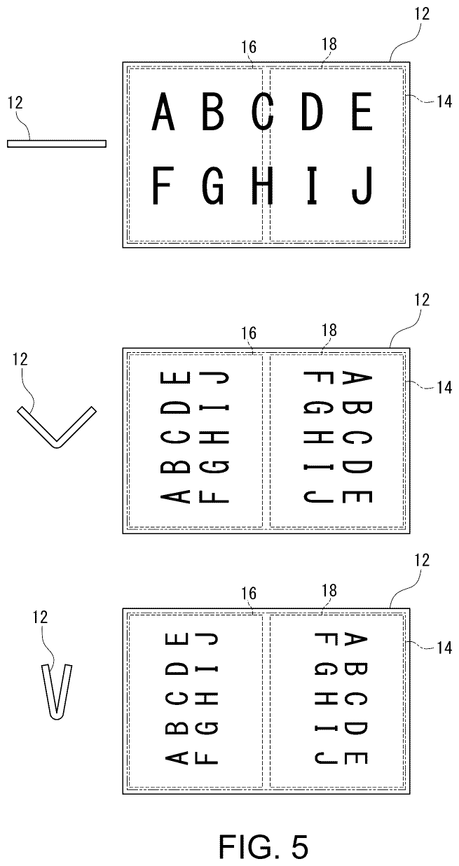

Further, the controller 40 may change the display mode of the image on the display 12 according to the posture of the display 12. FIG. 5 is a diagram showing a relationship between the posture of the display 12 and an image display mode. In FIG. 5, the left side shows the posture of the display 12.

As shown in the first row of FIG. 5, when the display 12 is in a flat position, the controller 40 handles the first display area 16 and the second display area 18 as part of a continuous single display area 14. In this case, the controller 40 may display an image also at a boundary portion between the first display area 16 and the second display area 18.

As shown in the second and third rows of FIG. 5, when the display 12 is in the bent posture, the controller 40 treats the first display area 16 and the second display area 18 as separate display areas independent of each other. In this case, the controller 40 may display the same image or different images in the first display area 16 and the second display area 18.

Further, the controller 40 may correct the images displayed in the first display area 16 and the second display area 18 according to the bending angle θ. For example, as the bending angle θ is larger and the inclination angles of the display areas 16 and 18 are closer to horizontal, the user 100 seems that the image is compressed vertically. Therefore, as shown in the second and third rows of FIG. 5, the controller 40 may perform correction to expand the image in the vertical direction as the bending angle θ increases. Thereby, the deformation of the image caused by the inclination angles of the display areas 16 and 18 is canceled out.

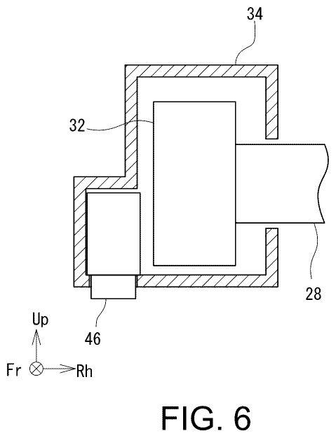

As is apparent from the above description, in this example, the slide rail 34 is fixed to the cabin ceiling 54. A lighting fixture 46 may be disposed inside the slide rail 34. FIG. 6 is a schematic cross-sectional view of the slide rail 34 in this case. As shown in FIG. 6, a recess may be formed in the slide rail 34 to accommodate a part or all of the lighting fixture 46, and the lighting fixture 46 may be disposed in the recess. In this case, the lighting fixture 46 may be used as a room lamp that illuminates the vehicle interior. The lighting fixture 46 may also be used as lighting for reducing eye fatigue of the user 100 utilizing the display 12. In other words, when the back surface of the display 12 is dark, the contrast of lightness and darkness between the display 12 and the back surface is too strong to cause eye fatigue of the user 100. Illumination of the back surface of the display 12 by the lighting fixture 46 incorporated in the slide rail 34 reduces such eye fatigue. Alternatively, other components such as speakers may be incorporated in the slide rail 34.

Any of the above description is an example. The configuration of the display system 10 may be appropriately changed as long as the display system 10 includes the configuration described in claim 1. For example, in the above description, the display 12 is bent along a line extending in the vehicle width direction. However, the display 12 may bend along lines extending in other directions. For example, the display 12 may be positioned between the left seat and the right seat and may bend along a line extending in the front-rear direction. Further, the display system 10 may not include the U/I device 36 and the seat sensor 38. In addition, a bezel portion that does not display an image may be provided at a boundary portion between the first display area 16 and the second display area 18.

1. A vehicle-mounted display system comprising
a display attached to a cabin ceiling and configured to change between a flat posture and a bent posture, wherein
the display in the flat posture has a flat shape along the cabin ceiling,
the display in the bent posture is bent such that respective ends in a first direction are closer to each other and convex downward than in the flat posture, and
the display has a display area visible from both sides in the first direction with the display therebetween.

2. The vehicle-mounted display system according to claim 1, further comprising
a controller configured to control the display of the display area, wherein
the display is a bendable sheet-shaped display device,
the display area includes a first display area visible from one side in the first direction of the display, and a second display area visible from the other side in the first direction of the display when the display is in the bent posture,
the controller is configured to treat the first display area and the second display area as a single continuous display area when the display is in the flat posture, and
the controller is configured to treat the first display area and the second display area as independent display areas when the display is in the bent posture.

3. The vehicle-mounted display system according to claim 2, wherein
the controller is configured to:
switch the posture of the display between the bent posture and the flat posture according to a type of image displayed on the display,
change a bending angle, which is an angle between the first display area and the second display area, according to at least one of a user's instruction and a reclining angle of a seat seated by the user, and
correct an image displayed on the display according to the bending angle.

4. The vehicle-mounted display system according to claim 2, further comprising
a changing mechanism for changing the display between the flat posture and the bent posture, wherein
the changing mechanism comprises:
a slide roller connected to an end of the display in the first direction;
a slide rail extending in the first direction on the cabin ceiling, and which guides a sliding movement of the slide roller; and
an actuator that moves the slide roller along the slide rail, and
the controller is configured to change an angle between the first display area and the second display area through the sliding movement of the slide roller.

5. A vehicle comprising:
the vehicle-mounted display system according to claim 1, and
at least two seats arranged to face each other on both sides in the first direction with the display therebetween.
